(19) United States
(12) Patent Application Publication
(10) Pub. No.: US 2002/0130657 A1
(43) Pub. Date: Sep. 19, 2002

(54) Absolute angular position sensor by using gear

(76) Inventor: Hui Li, Vancouver (CA)

Correspondence Address: HUI LI, 10800 SEAHURST PL, RICHMOND, BC, V7A3Z8, CA

(21) Appl. No.: 09/771,510

(22) Filed: Jan. 29, 2001

(51) Int. Cl. G01B 7/30

(52) U.S. Cl. 324/207.21

(57) ABSTRACT

An apparatus for sensing the absolute angular position of a rotatable shaft comprising one of eccentrically mounted gear having a bigger diameter of central mounting hole than the diameter of the said rotatable shaft, a permanent magnet, and an array of preferably four equally tangentially spaced magnetic field sensors positioned between the gear and the magnet along a line tangent to the gear, and close to the gear. An absolute angular position of rotatable shaft is provided with high accuracy by using a signal processing means and previously known signal amplifier circuitry.

### FIELD

This invention relates to angular position sensor, and in particular to simple non-contact means to determine absolute angular position of a rotating shaft of, for example, an electric motor.

### BACKGROUND OF THE INVENTION

One conventional way to measure the absolute angle of the shaft of an electric motor is by measuring the field of single magnet attached to the shaft so that the magnet spins with the shaft. A number of stationary sensors located around the magnet measure the magnetic field of the magnet. As the magnet spins, the waveform of the measured magnetic field is near sinusoidal and can be used to calculate the position and the rotational speed of the shaft. It has been found, however, that the most accurate measurements are provided if the magnet is as close to perfectly circular as possible. Such magnets are difficult and expensive to make. Another problem is that adding magnets increases the inertia of the shaft.

As discussed in U.S. Pat. No. 5,367,257 issued to Garshelis, it is known to sense without contact the motion of rotating members by either (1) adding magnetic poles to a circumferential region of a rotating member, either by attaching discrete permanent magnets or by permanently magnetizing local regions of the rotating member, or (2) providing a toothed, ferromagnetic circumferential region of the rotating member(referred to as a cogwheel herein, even though gears are typically not involved) and a stationary permanent magnet near the rotating member. In the first case, a magnetic field sensor is placed close to the portion of the rotating member having the magnetic poles. In the second case, the magnetic field sensor is placed between the toothed region and the stationary permanent magnet.

Depending upon the character of the shaft, teeth can be cut into the shaft, or a toothed sleeve or bushing or the like can be mounted on the shaft to rotate with the shaft. The magnetic field sensor detects changes in the magnetic field caused either by the motion of the magnetic poles past the sensor or by the variation in the permeance of the magnetic circuit between the toothed ferromagnetic region of the rotation member and the permanent magnet as the teeth move past the permanent magnet. Active magnetic field sensors such as Hall effect sensors or magnetoresistive sensors are preferred. To achieve accurate measurements, it is necessary to have closely and accurately spaced magnetic poles or notches on the rotating member; these can be difficult and expensive to provide.

Both of the above sensing methods discussed by Garshelis provide only relative angular position unless at least one position on the rotating member is specially marked and the sensor and associated circuitry are configured to distinguish the marked position. If that is done, the absolute position can be calculated, once the mark has passed the sensor, by counting the number of passages of the mark.For an example, see U.S. Pat. No. 5,568,048 issued to Schroeder et al. If no special mark is used, only the position relative to the initial power-up position can be provided.

The present invention was developed from an analysis of a variation on the previously known devices using a cogwheel for sensing relative angular position. This variation includes a sensor module containing four magnetoresistive sensors in a linear array. The array of sensors is aligned in the plane of the gear and in a tangential direction with respect to the gear, and is positioned close to the gear so that the teeth of the gear move past the sensors as the gear rotates. The spacing of the sensors is one-quarter of the distance between the centers of successive teeth of the gear.

Based on that analysis, a 180(deg) range absolute angular position sensor by using cogwheel(gear) is presented instead of relative position.

### SUMMARY OF THE INVENTION

The present invention also use the previously known device, gear, for sensing 180(deg) absolute angular position instead of relative angular position.

The difference is that the diameter of gear mounting hole is little bit bigger than the diameter of measured object shaft, so the gear and the measured object shaft will be eccentric after the gear is mounted on the object shaft.

The sensor module in the intention is in a tangential direction with respect to the gear, and is positioned close to the gear so that the teeth of the gear move past the sensors as the gear rotates. The spacing of the sensors is one-quarter of the distance between the centers of successive teeth of the gear.

It is also preferable for the tooth form of gear to be sinusoidal or approximately sinusoidal(e.g.trapezoidal) to produce more precise sinusoidal quadrature sensor output signals.

The invention may additionally include a magnet proximate to the sensor array and positioned to establish a magnetic field through the sensors in the sensor array to the gear.

As the gear is turning, the amplified output signals of sensor module will be two modulated quadrature signals. In the present invention, a method is included to transfer the two modulated quadrature signals into two standard sinusoidal quadrature signals and an amplitude signal which is used to determine the absolute angular position.

### BRIEF DESCRIPTION OF THE DRAWINGS

FIG. 1 is a schematic axial-sectional fragment view of a gear and sensor module in accordance with invention.

FIG. 2 (prior art) is a schematic circuit diagram of the sensor module and associated electronic circuitry.

FIG. 3 is a set of signal waveforms as the measured object shaft turned 380(deg), the signals include modulated quadrature and transferred standard quadrature sinusoidal also amplitude for determine absolute position.

### DETAILED DESCRIPTION OF THE PREFERRED EMBODIMENT

One preferred embodiment of the invention is the combination of a gear with a sensor module and associated electronic circuitry designed for use in previously known apparatus for signal amplifier.

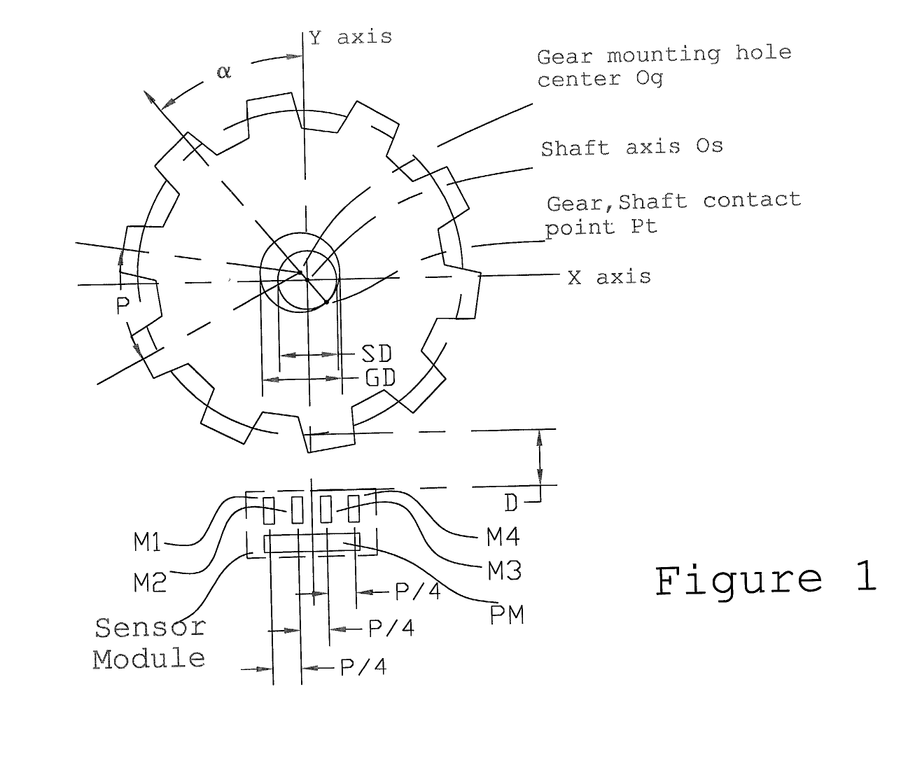

As shown in the FIG. 1, the gear with a central hole is fixed to the measured object shaft, also the diameter of the gear central hole is little bit bigger than the diameter of measured object shaft. So as the shaft is turning, some of the teeth will be near the sensor module and others will be little bit far away from the sensor module because of the effect of eccentricity. Although only ten teeth are shown in the FIG. 1, the actual teeth number can be more or less depends upon the application.

A magnetic field is produced by a fixed permanent magnet PM located within the sensor module, which is positioned close to the gear without contact. The sensor module also includes an sensor array of magnetoresistive or other suitable sensors M1, M2, M3, and M4 positioned between the gear and the permanent magnet PM.

The gear has several teeth with teeth pitch P. A sensor module, comprised of a permanent magnet PM and four magnetoresistive sensors M1, M2, M3, and M4 oriented in the plan of gear and in the tangential direction with respect to the gear, is positioned close to the periphery of gear without contact. The sensors M1, M2, M3, and M4 are spaced in a distance P/4 from one another as shown in the FIG. 1.

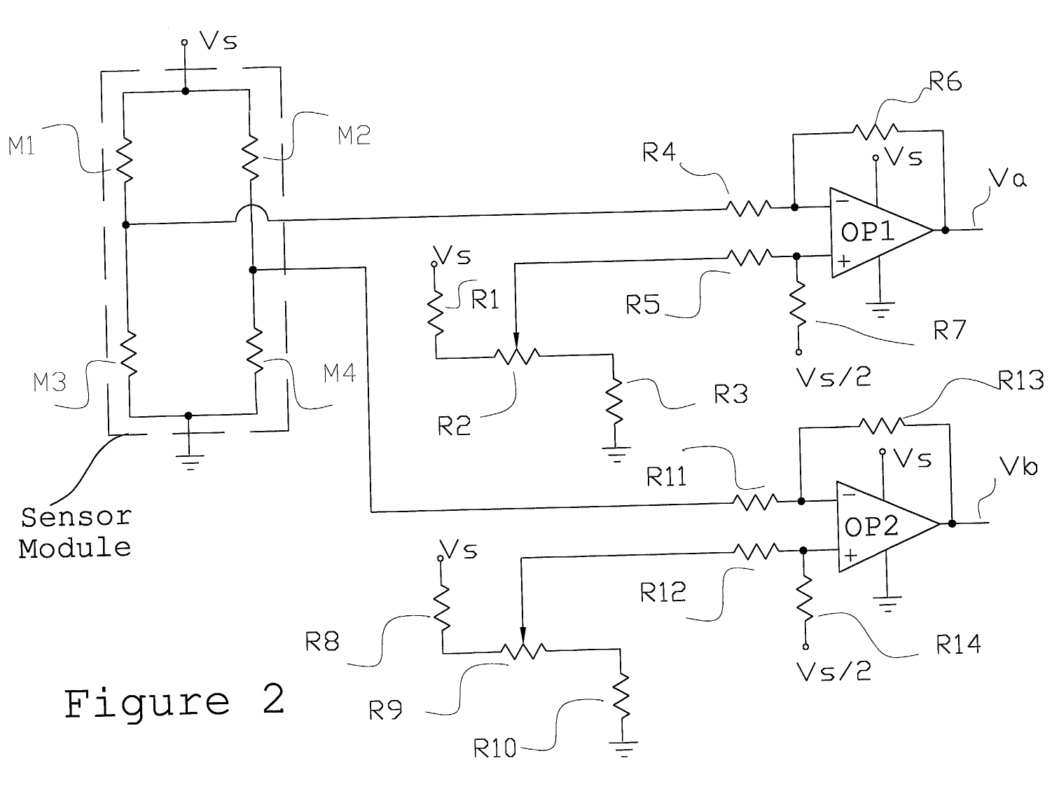

FIG. 2 illustrates suitable electronic circuitry used in conjunction with the gear, including that of the sensor module of FIG. 1. The sensor module contains four magnetoresistive sensors M1, M2, M3, and M4, and interconnected as illustrated in FIG. 2.

To indicate the module character of the array of sensors M1 to M4, the array is shown enclosed in broken lines and indicated by sensor module in FIG. 2 and FIG. 1, but the schematic presentation of the sensors M1 to M4 in FIG. 2 is not intended to reflect the geometry of the array, which is more accurately depicted in FIG. 1. The balance of FIG. 2 outside sensor module comprises the circuit used for measuring the resistance values of M1 to M4 and from them computing the absolute angular position of the shaft.

Note that as the gear rotates with the shaft, every teeth will continue to pass by the sensor module in sequence. Each of the teeth has similar effect on the sensor module, but not exactly the same because of the effect of eccentricity.Some of teeth have more effect on the sensor module, and some of teeth have less. That difference is used to determine the absolute position of each teeth.

The measurement circuit shown in FIG. 2 also includes two operational amplifiers OP1 and OP2, which may if desired be provided by a singly module.Resistor pair R4 and R5, normally of the same resistance value, and resistor pair R6 and R7, normally of the same resistance value, determine the gain of the operational amplifier OP1, subject to fine adjustment by potentiometer R2, which is typically adjusted to limit the output voltage of operational amplifier OP1 to a range acceptable as a useful voltage range. Resistor pairs R11 and R12 of the same resistance value and R13 and R14 of the same resistance value similarly determine the gain of the operational amplifier OP2, again subject to fine adjustment by potentiometer R9, which is typically adjusted to limit the output voltage of operational amplifier OP2 to a range acceptable as a useful voltage range.

As shown in FIG. 1, there is only one contact point for both the gear and shaft after the gear is mounted on the shaft because of the different diameter for central gear mounting hole and the shaft.

So the gear and shaft contact point Pt, shaft center Os, and the gear mounting hole center Og are in a line, and the angle between that line and Y axis is denoted as α. Actually the point Os is the turning center of both gear and shaft.

As the tested results, there will be one cycle of modulated quadrature sinusoidal signals output from amplifier OP1 and OP2 if one of the teeth passed the sensor module.

When the α is zero (deg), gear is somehow most far away from the sensor module, or the gear and the shaft contact point Pt is the most close to the sensor module, so the amplitude of modulated quadrature sinusoidal signals output from amplifier OP1 and OP2 is the smallest.

When the α is 180(deg), the gear is the most close to the sensor module, or the gear and the shaft contact point Pt is the most far away from the sensor module, so the amplitude of modulated quadrature sinusoidal signals output from amplifier OP1 and OP2 is the biggest.

There are two typical output signals of Va and Vb for the gear 360(deg) turning around shaft, the teeth number supposed to be 10, and the Va and Vb both are modulated quatrature sinusoidal, but they are 90 (deg) shafted.

Generally, the teeth number is supposed to be n, here n is integer, and the outputs Va and Vb from amplifier OP1 and OP2 can be expressed as:

Va=Vs/2+(A−B cosα)sinθ

Vb=Vs/2−(A−B cosα)cosθ

Here A and B are positive constants, also A>B. Vs is the power supply voltage for the sensor module and amplifier circuit. The 0=n α, n is the gear teeth number.

For convenience, two of new variables are introduced as

Ea=Va−Vs/2

Eb=Vb−Vs/2

Since Vs is a known value, so Ea and Eb are measurable:

The amplitude Am of sinusoidal signals Va and Vb, which is theoretically expressed as A−B cosα, can be expressed by measured variables as

$$Am = \sqrt{E {a}^{2} + {Eb}^{2}}$$

also

Sin_Phase=Ea/Am

Cos_Phase=Eb/Am

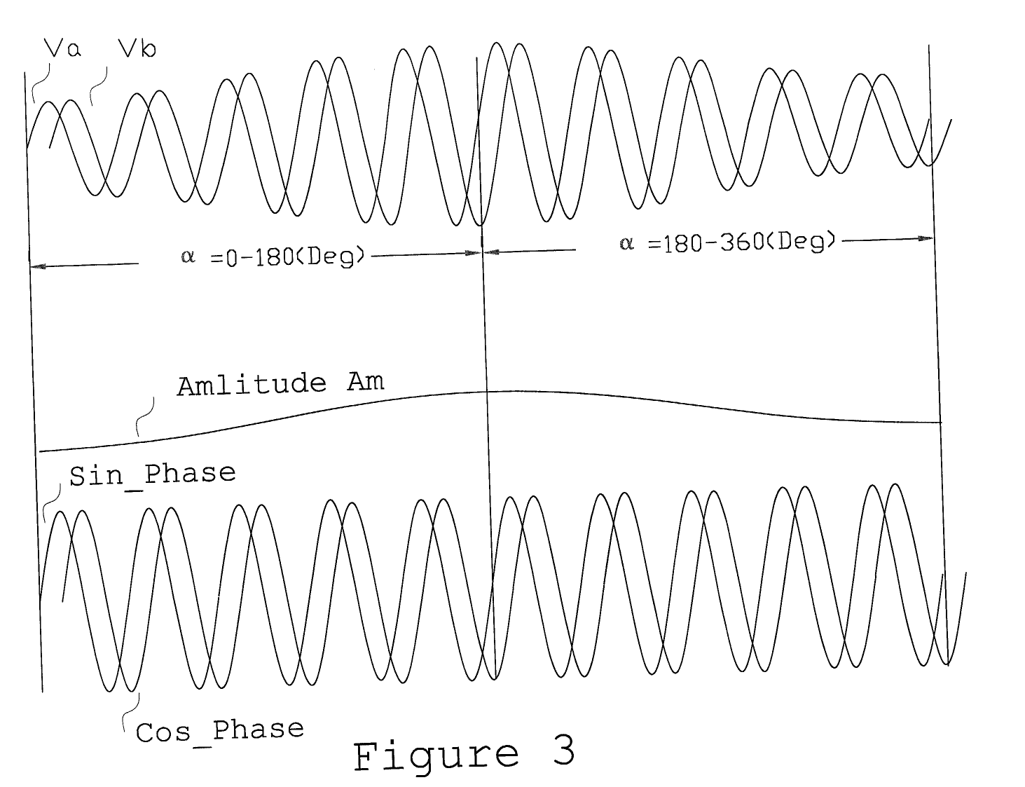

As shown in the FIG. 3, Am is a long period signal, one cycle for one turn of the shaft,which can be used to determine which tooth is near the sensor module or calculate the absolute angle of a for the range of 0-180 (deg) or 180-360(deg) roughly.

The Sin_Phase and Cos_Phase are the standard quadrature sinusoidal signals, one cycle of those two signals for one tooth, which can be used to determine the angle of θ (=n α) then calculate α with high accuracy.

There are several conventional way to calculate angle from standard quadrature sinusoidal signals.

What is claimed is:

1. For determining the absolute angular position of a shaft, the combination of
(a) a gear mounted eccentrically on the shaft,whose absolute angular position bears a predetermined relationship to the absolute angular position of the said shaft;
(b) a sensor array comprising a plurality of sensors arranged proximately to the mounted gear in a spaced series extending generally tangent to the gear, each sensor in operation measuring the instantaneous distance between the surface of gear tooth and the sensor and providing a representive of the instantaneous distance thus measured;
(c) signal processing means for processing the outputs of the sensors and for determining the absolute angular position of the shaft.

2. In combination
(a) a gear mounted eccentrically on the shaft with a bigger diameter of central mounting hole than the shaft diameter;
(b) an array of sensors in tangential spaced alignment along a line generally tangent to the gear, said sensors being positioned closely proximate to the surface of gear tooth and having a spacing apart from one another such that the sensor array spans the tangential distance between two sequential teeth, and where in each sensor senses the instantaneous radial distance from sensor to the nearest tooth of gear and generates an output signal representive of the instantaneous radial distance; and
(c) signal processing means responsive to the output signals of the sensors for providing the necessary signals to determine the absolute angular position of the shaft.

3. The combination of claim 2, wherein the tooth profile of the gear is sinusoidal or approximately sinusoidal(e.g., trapezoidal).

4. The combination of claim 3, wherein the sensors are magnetoresistive sensors, and additionally comprising
(d) a magnet proximate to the sensors and to the gear for establishing a magnetic field between the sensors and the gear.

5. The combination of claim 4, wherein the sensors are spaced apart from one another by a distance equal to the gear tooth pitch divided by the number of sensors in the array.

6. The combination of claim 4, wherein the number of sensors is 4. Every individual sensor in the sensor array is denoted as M1,M2,M3,and M4 in the way of M2 next to M1, M3 next to M2 and M4 next to M3.

7. The combination of claim 4, wherein the output signals from sensor array are provided by the two of the voltage dividers, one divider comprising M1 and M3, the other divider comprising M2 and M4.

8. The combination of claim 7, wherein the amplified signals from sensor array comprising Va and Vb as
Va=Vs/2+(A−B cosα)sinθ
Vb=Vs/2−(A−B cosα)cosθ

9. The combination of claim 8, wherein the Amplitude Am for Va and Vb, standard quadrature sinusoidal signals Sin_Phase and Cos_Phase are calculated from Va,Vb and Vs as
$$Am = \sqrt{E {a}^{2} + {Eb}^{2}}$$
also
Sin_Phase=Ea/Am
Cos_Phase=Eb/Am
Here Ea=Va−Vs/2, Eb=Vb−Vs/2

10. The combination of claim 9, wherein the Amplitude Am is used to determine shaft angle α for 0-180(deg) or 180-360(deg) roughly, and Sin_Phase and Cos_Phase are used to determine detail angle of θ (=n α) then for calculate α with high accuracy.
